(19) United States
(12) Patent Application Publication
(10) Pub. No.: US 2016/0240032 A1
(43) Pub. Date: Aug. 18, 2016

(54) MODULAR OUTDOOR LARGE ITEM VENDING SYSTEM

(71) Applicant: JALH Enterprises d/b/a Outdoor Vending Solutions, Granbury, TX (US)

(72) Inventors: John S. Agor, Granbury, TX (US); Leonard J. Halsey, JR., Granbury, TX (US)

(21) Appl. No.: 14/818,673

(22) Filed: Aug. 5, 2015

Related U.S. Application Data
(60) Provisional application No. 62/117,317, filed on Feb. 17, 2015.

(51) Int. Cl. G07F 7/08; G07F 9/00; G07F 9/10

(52) U.S. Cl. CPC G07F 7/088; G07F 9/10; G07F 9/006

(57) ABSTRACT

A modular outdoor large item vending system for large items such as firewood, grill wood, cases of drinking water, or charcoal. The vending system can be placed on a store front, parking lot, campsite, or park, and comprises a master module assembly connected to a plurality of add-on module assemblies with each of the master module assembly and the add-on module assemblies having compartments to hold large items which are dispensed from the compartments when a payment is made through a credit card reader interface located on a master module control compartment door face. The large item vending system of the invention is powered by DC batteries charged by AC power and/or solar power, or by other power means. The master module assembly and add-on module assemblies can be connected to a manual assembly for dispensing large items if there is a power failure.

### CROSS REFERENCE TO RELATED APPLICATION

This application claims priority under 35 USC 119(e) to U.S. Provisional Patent Application Ser. No. 62/117,317 filed Feb. 17, 2015 which is incorporated herein by reference, in its entirety.

### FIELD OF THE INVENTION

The present invention is generally related to vending systems. More particularly, the invention is related to a vending system for dispensing items outside a storefront or in a campsite, park or similar venue.

### BACKGROUND OF THE INVENTION

The use of self-service vending machines to dispense food, beverage(s), movies and other items is well-known in the art. A majority of these vending machines are generally located outside a storefront to save retail space within the interior of the store. Large, bulky items such as ice and firewood require special vending systems that can accommodate the individual sizes of these items. In the case of items such as firewood, charcoal, deer corn and other such large and bulky items, the general practice in the past has been to load these items on palettes and store them on those palettes in front of stores for the customers to pick up. However, the customer has to go inside the store to make a payment for these items before they can pick them up from the palettes outside the store, which is an inconvenience. Storing products in the open outside the store also makes it possible for some to carry away the items without paying for them.

If the large items are stored in locked containers outside the store to deter theft, the customer may have to wait a period of time for the store personnel to come out and unlock the containers to access the items. This inconvenience of waiting for assistance from store personal to access these bulky items and pay for them is magnified if the store is closed for the day and the customer has to make another trip to the store when it is open to purchase the items. Additionally, having the products locked up and inaccessible to customers when the store is closed precludes the efficient sale and profitability of these items.

Vending machines for dispensing large items are known, for example, U.S. Pat. No. 6,761,194 (Blong) which describes a system for dispensing a plurality of pressurized propane tanks, U.S. Pat. Appl. Pub. 2014/0103062 (Rose JR. et al.) which describes a combination vending/return apparatus for storing and dispensing unfilled and filled large volume water-containing bottles and U.S. Pat. No. 8,936,173 (Fleishman) which describes a vending machine for holding bulk goods. U.S. Pat. No. 5,538,159 (Snyder et al.) describes a portable wood dispenser with individual compartments for storing firewood and dispensing the wood through tokens, slugs or a purchased key and U.S. Pat. Appl. Pub. 2007/0151981 (Halsey, S R, et al.) describes a firewood vending machine. However, none of these vending systems for dispensing bulk items uses a modular system that has the capability to add-on and efficiently integrate additional modules to the main systems, such as by connecting a wiring harness from the existing module's computing hardware to the new module's computing hardware and attaching the new module to the system using module attachment hardware. Prior art vending systems generally use voltage regulators that convert AC to a 24 volt DC and do not use DC batteries. As a result, current electronic vending systems are unable to operate when the AC (Alternating Current) is interrupted, degraded, or otherwise unavailable.

U.S. Pat. No. 8,712,585 (Bruck et al.) describes a vending apparatus and system that includes the use of optional modules and U.S. Pat. Appl. Pub. No. 2015/0102051 (Shimmerlik et al.) describes a modular vending machine system with re-loadable vertical product dispensing modules. These prior art vending systems are meant for use within a store to dispense consumable products and not for dispensing large and bulky items such as firewood, grill wood, charcoal and other such items.

Therefore, there is a need for a modular outdoor vending system for storing and dispensing large bulky items outside a store front, or in remote areas such as state parks and camping sites. There is a further need for a vending system that does not require continuous AC power for its operation. The vending system can ideally be operated using DC batteries which can be continuously charged by AC power or a solar power so that the system continues to operate during power interruptions.

### SUMMARY OF THE INVENTION

Embodiments of the modular outdoor vending system of the present invention substantially meet the need for an all-weather outdoor vending system for dispensing, large, bulky items such as firewood, grill wood, charcoal, deer corn, cases of water and other items. In an embodiment, the invention dispenses such products from modular units that are connected to and controlled by a master unit. The modularity of the invention allows it to be scaled in accordance with the needs of the retailer, i.e., additional modular units can be attached to the master unit to accommodate available space and demand. The master unit immediately integrates and controls as many add-on modules as are desired.

In an embodiment, the vending system has a modular feature that allows it to be sized to available space by connecting one or more add-on modules in line with the existing modules. An add-on module can be added to the master module by clamping the modules together and connecting the wiring harness of the add-on module to the wiring of the existing add-on module. In accordance with this embodiment, the master module can electronically acquire the new add-on module and assimilate it into the system so that it is substantially immediately ready for vending. Thus, the system can be quickly scaled to use as many additional add-on modules as required or desired. Each module can be set with different pricing to assure that multiple types of products can be dispensed from one system.

A system of the present invention thus allows retailers to carry and sell large or otherwise bulky items that might take up considerable floor space within retail premises, or that might be stored outside retail premises in an unsecured and unprotected environment. In an embodiment, the system enables customers to purchase such items by credit or debit cards without any assistance from store personnel and without the need to enter the store to pay for the items. Retailers can thus stock and sell large or otherwise bulky items in a fully secure and unsupervised manner both within and outside of normal operating hours. Accordingly, the invention frees retailers from having to move, restack, or re-arrange large items to avoid obstructions or unsightly displays, or from having to constantly monitor the premises to prevent thefts of large items stored outside.

In an embodiment, the vending system of present invention is DC (Direct Current) powered and continuously recharged using either AC (Alternate Current) power or solar power using an optional onboard mounted, commercially available solar panel(s) to charge the primary DC batteries via a solar charge controller. The feature of having AC power recharge the DC batteries allows system operation during power interruptions of up to 24 hours. In addition, the ability to use solar energy to power the system allows the vending system of the invention to be placed away from the store front and positioned in a parking lot or in remote areas such as state parks, camping sites and other recreational areas where AC power is not available, thereby substantially eliminating the need for AC power to power the system and the expenditure involved in using AC power. The ability to use solar power to operate the DC batteries allows the system to operate for up to four days without access to power. With solar capabilities, convenient, access to camping items such as wood, charcoal and cases of water 24 hours per day, seven days per week is now possible with the system of the present invention. In sum, various embodiments of the present invention can save time, money, and storage space and provide a convenient, secure and reliable way to make large and bulky items available to the consumer all day, every day, without the need for retailer assistance or supervision.

In an embodiment, the vending system of the present invention has a master module control box with a product selection display and a key pad with item prices indicated next to the products and a credit card reader interface to execute payments for the product purchase using a credit or debit card. Once payment is accepted by the system, the door of the compartment holding the firewood or other large item is electronically unlocked and can be opened, thereby allowing the user to remove the item and subsequently close the door. In various embodiments the door can be opened automatically by the system or manually opened by the user. Once the door is closed, it is automatically locked. The compartment will generally not vend again until an item is restocked in the compartment and the system is reset by the operator.

In an embodiment, software programming of the vending system assures that when the last item in a module or compartment is vended, the display will indicate that the item is sold out and prompt the user to make another selection. The system will not charge the customer until they select an item that is available. Once the software receives a selection from the customer, it prompts the customer to swipe a credit/debit card via an LCD display and by flashing three blue lights on the card reader. Once the card is swiped, the card reader checks for available funds through an onboard cellular data uplink. If funds are not available, the display prompts the customer to try another card. If funds are available, the software then communicates with the master module, which determines which module will vend that particular item and the next available door with that selection will open. Master module control software generally allows the operator to open all doors in any module (main module software sends a signal to each lock in that module and they all unlock and open) to facilitate restocking. The display also allows the operator to determine that all modules have been found and assimilated, and set prices for each individual module.

### BRIEF DESCRIPTION OF THE DRAWINGS

FIG. 1 is a front view of an embodiment of a modular vending system illustrating the master module assembly of the invention attached to an add-on module assembly;

FIG. 2 is a perspective view of the modular frame of a single module assembly structure of an embodiment of a modular vending system;

FIG. 3 is a perspective view of the modular frame of a single module assembly structure of an embodiment of a modular vending system illustrating module exterior coverings and module compartment floor coverings;

FIG. 4 is a side view of an embodiment of a modular vending system;

FIG. 5 is a perspective view of an embodiment of a modular vending system illustrating two modules aligned next to each other and module interlocking hardware of the system securing device;

FIG. 6 is a front view of the module door assembly of an embodiment of the modular vending system;

FIG. 7 is a front view of the master module control compartment face of an embodiment of the modular vending system;

FIG. 8 is an exploded perspective view of the master module computing system of an embodiment of the modular vending system;

FIG. 9 is an illustration of a perspective view of a plurality of add-on module computing and hardware of an embodiment of the modular vending system;

FIG. 10 is a front view of a manual module assembly an embodiment of the modular vending system;

FIG. 11 is a front view of an embodiment of the modular vending system illustrating a master module assembly and four add-on module assemblies; and

FIG. 12 is an illustration of an embodiment of the modular vending system in a parking space setup.

### DETAILED DESCRIPTION OF THE INVENTION

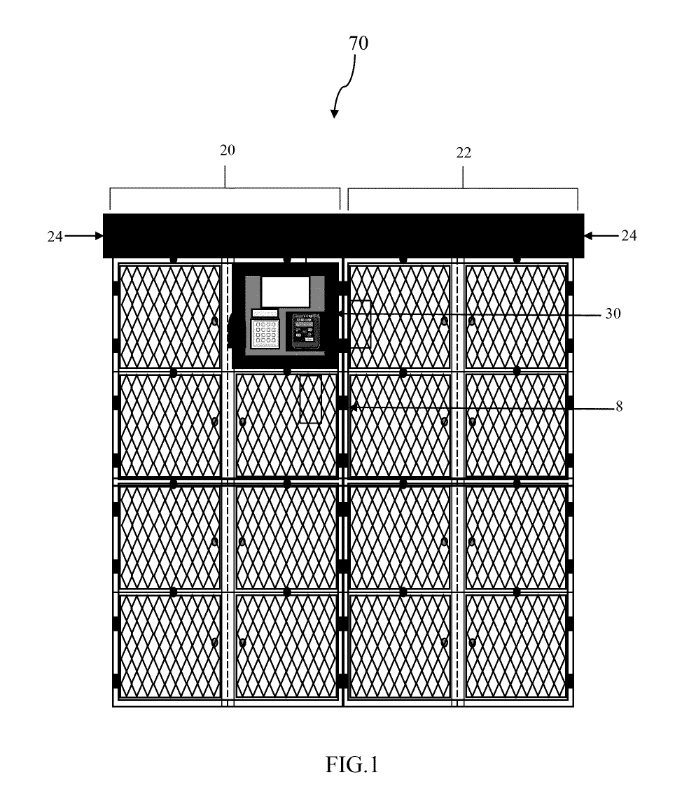

A modular vending system is generally depicted in FIGS. 1-12. Although the modular vending system can be used for any number of purposes, the illustrated embodiments are especially suitable for vending large and otherwise bulky items such as firewood, grill wood, charcoal, deer corn, and cases of water, among others. The modular design and features of the vending system of the present invention allow it to occupy less space in a store front as compared to other vending systems, thereby increasing store front aesthetics by eliminating the pile-up of bulk items on palettes in front of the store. In an embodiment of the modular vending system of the present invention, the master module can be electronically connected to additional modules to enhance the storage space for the items to be dispensed.

A power management system for modular vending system of the present invention may include DC batteries with AC power to continuously charge the batteries so that the system can operate for up to 24 hours in the case of power disruptions, or alternately on solar power which allows the DC batteries of the system to operate for up to four days. The invention can thus be operated even in remote locations that do not have access to electricity such as, parks, camping grounds and other recreational areas.

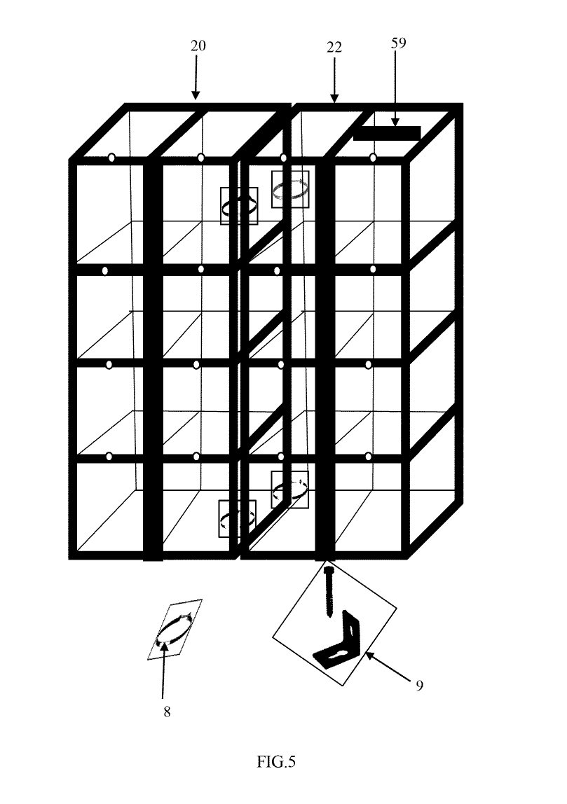

Referring now to the drawings, wherein like numerals represent like components in the several views presented and discussed, and more particularly referring now to FIG. 1, an embodiment of modular outdoor vending system 70 according to an embodiment of the present invention is depicted. Modular vending system 70 is generally comprised of a master module assembly 20 juxtaposed next to an add-on module assembly 22. As depicted in FIGS. 1 and 5, among others, master module assembly 20 can be attached to add-on module 22 with interlocking hardware 8. The master module assembly 20 has a master module control compartment interface 30 which is connected internally to a master module control box that also controls the functions of the compartments in the master module assembly 20 and add-on module assemblies 22. The add-on module assemblies 22 are typically of similar construction and materials as the master module assembly 20.

In an embodiment, add-on module assemblies 22 do not have battery or battery tender requirements so that items can be dispensed from all module compartments of the add-on module assemblies 22 through the master module control compartment interface 30. The master module assembly 20 and the add-on module assemblies 22 may be fitted with their own shed style roof 24 made of metal. Certain structural components of both master module assembly 20 and add-on modules assemblies 22 may be hot-dip galvanized prior to installing additional parts and equipment. In some embodiments, solar panels are installed on the roof 24 of the master module assembly 20 and add-on module assemblies 22 to charge the DC batteries.

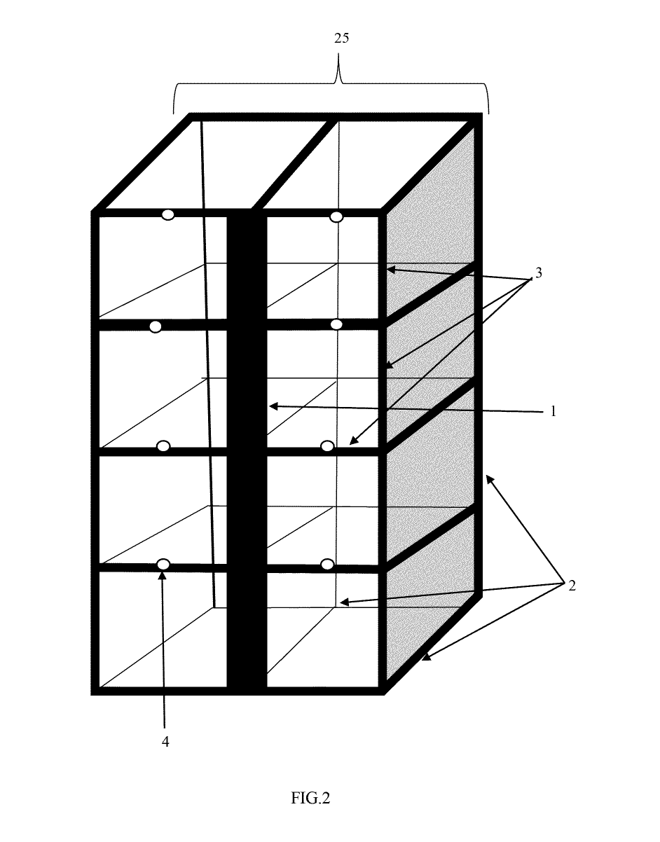

Referring to FIG. 2, modular frame 25 of a single module assembly structure may include metal iron channel 1, angle irons 2 and square metal tubing 3. Each module compartment generally has a door light 4 to provide the necessary illumination when removing items from the compartments.

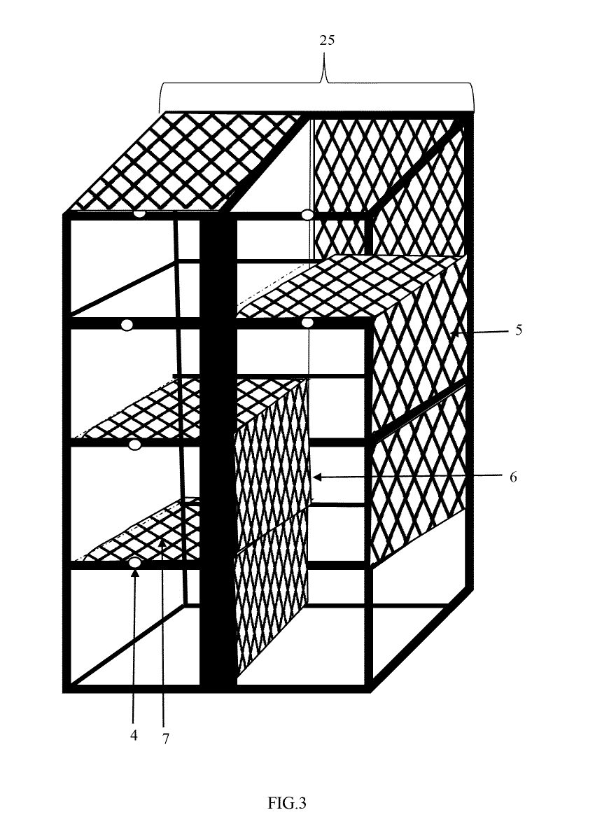

Referring to FIG. 3, modular frame 25 of a single module assembly may also include module exterior coverings 5, compartment dividers 6 and module compartment floor coverings 7. These parts are generally constructed from expanded mesh metal. Add-on module assemblies 22 generally do not have expanded metal covering on the left facing sidewall so that when they are attached together there are no double walls.

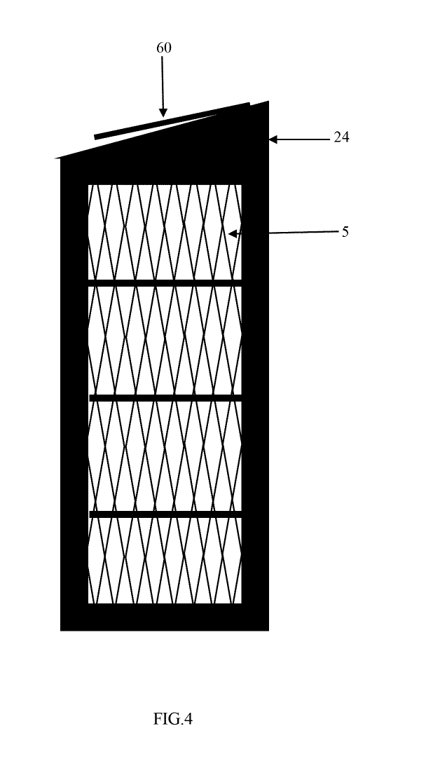

Referring to FIG. 4, a top module compartment is depicted with the module exterior covering 5 and a view of solar panel 60 on the roof 24 of the module. Solar panels 60 are generally placed on the add-on module assembly roofs 24 in a similar manner

Referring to FIG. 5, two modules are aligned next to each other showing the positioning of the module interlocking hardware 8 and an example of the system securing device 9. According to this embodiment, master module assembly 20 is juxtaposed next to an add-on module assembly 22. The add-on module 22 has the add-on module hardware case 59 positioned on the top module compartment. The add-on module assembly 22 is attached to the master module assembly 20 using the module interlocking hardware 8. Additional add-on module assemblies 22 may be linked together using the module interlocking hardware 8 to form a plurality of configurations. System securing devices 9 are attached to each module assembly and the ground and/or wall next to the module assemblies to assure that the system is properly secured and will not topple and injure potential customers trying to access the module compartments to retrieve items.

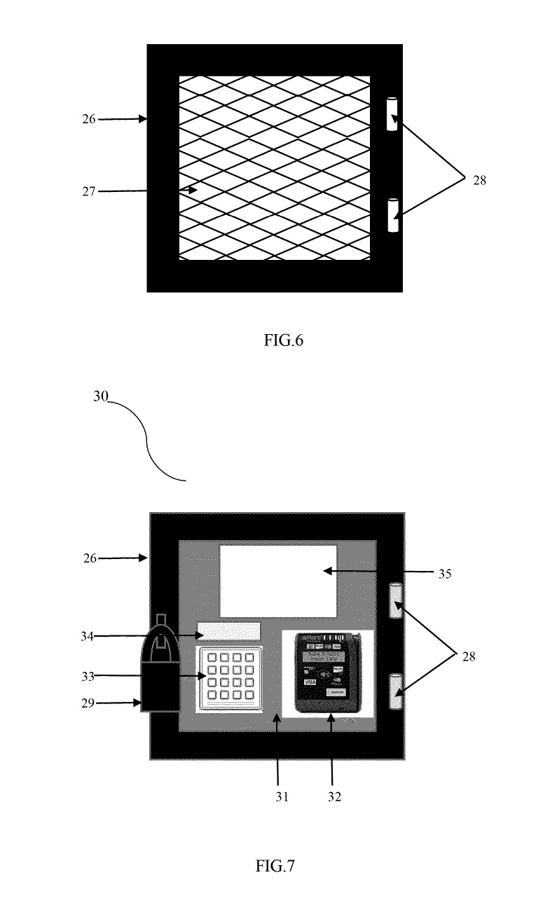

Referring to FIG. 6, the module compartment door assembly of the present invention is depicted. Each door assembly generally has a door frame 26 with a door covering 27 constructed of expanded mesh metal and hinges 28.

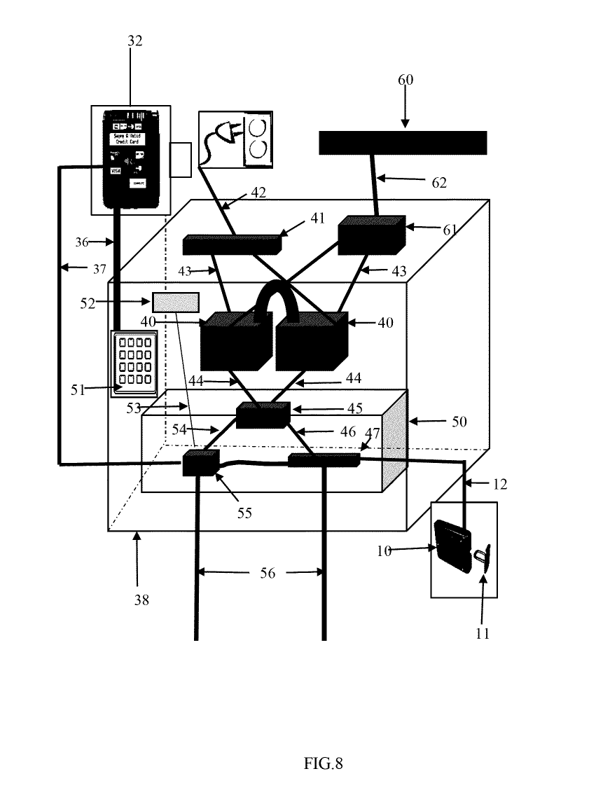

As depicted in FIGS. 6 and 7, the master module control compartment interface 30 may be constructed of plate steel door covering 27 mounted to a door frame 26 and hinges 28. The master module control compartment interface 30 may be housed within the doorframe 26 and secured with a key operated padlock 29. The master module control compartment face 31 has a credit card reader interface 32, a product selection keypad 33 and a product selection LCD display window 34 connected to the credit card reader interface 32 via a card reader/keypad wiring (not shown) and securely mounted on the master module control compartment face 31 and also has an item/price placard display 35 that provides the user with information to select the desired item via the product selection keypad 33 and the product selection LCD display window 34.

Referring to FIG. 8, the master module computing system and associated hardware are shown. The master module control box 38 is housed within the upper right hand compartment of the master module assembly and consists of the master module control compartment interface 30. Within the master module control box 38 may reside an AC power cord 42 that connects AC power directly to a battery tender 41 which charges and maintains two wired-in series 12v (volt) DC batteries 40 creating a 24 Volt system. The batteries 40 generally connect to two voltage transformers 45 via battery wiring 44. One voltage transformer 45 sets up a 7 volt DC current to power the master module computing hardware 55 and add-on module computing hardware (not shown here) as well as the controller side of the relays 47 in the master and add-on modules. The second voltage transformer 45 sets up a 24 volt DC current to power the duty side of the relays 47 to open doors in the master and the add-on units via relay wiring 46. The relays 47 provide power to the electronic locking devices 10 and 11 and the door lights 4 (not shown here) via electronic locking device wiring 12 and keeps them open for a predetermined period of time and simultaneously powers the appropriate door lights 4 so that the associated module compartment can be accessed and the contents removed by the user. The master computing hardware 55, the relays 47 and the dual voltage transformers 45 are housed within the master computing hardware case 50 which is waterproof. The master control data entry keypad 51 and the master control data and diagnostic LCD display 52 are connected through the keypad and diagnostic display wiring 53 and to the master computing hardware 55 through the master control wiring 54. The master computing hardware 55 is connected in series to each additional add-on module through the module interconnecting wires 56 consisting of two wires for a 24 Volt DC circuit, two wires for a 7 Volt DC circuit and three wires for a data communication circuit that runs between all modules.

A modular vending system according to an embodiment of the present invention is powered by DC batteries 40 that can be continuously re-charged and maintained using a battery tender connected to a 110 VAC power source. The batteries allow for the system's operation if there is an AC power interruption. Alternately, the system can be operated using solar power. To that end, commercially available solar panels 60 can be installed on the roof of the master and add-on module assemblies to charge the DC batteries 40 via a solar power charge controller 61 connected to the solar panels 60 through solar collector wiring 62. The solar power charge controller 61 relays the solar energy collected through the solar panels to the DC batteries 40 through the battery wiring 43. The optional capability of using solar panels 60 for powering the DC batteries of the vending system allows the system to be placed at a distance away from the store front, in a parking lot, or in other remote areas such as state parks and camping sites where AC power may not be available. Besides eliminating the need for AC power requirement to operate the vending system of the invention, the use of solar power can also lower the energy required to operate the system while increasing functionality.

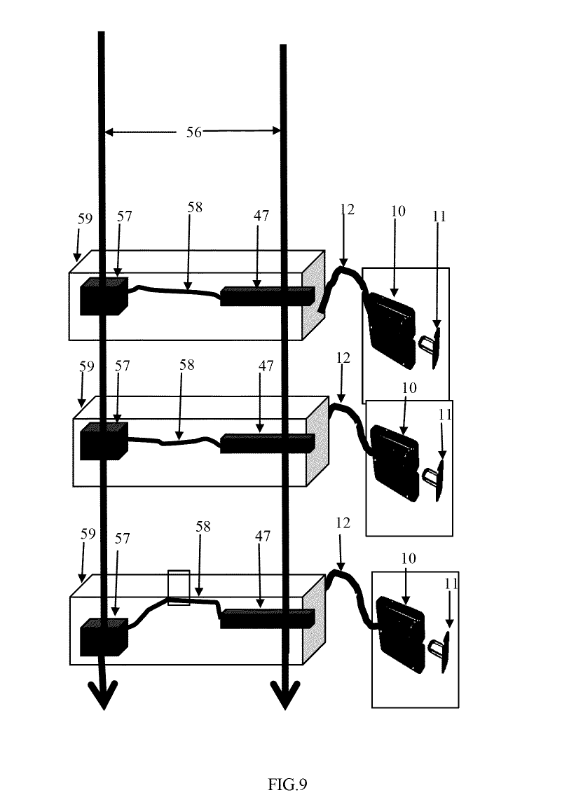

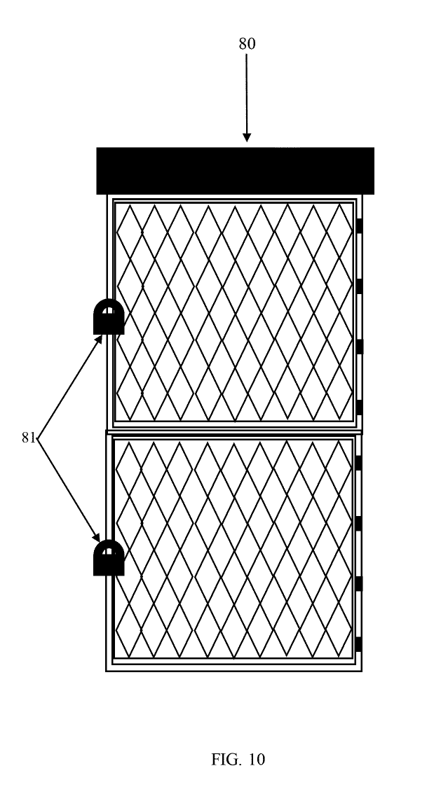

Referring to FIG. 9, a plurality of add-on module computing and associated hardware are shown connected to the master module control box. Each of the add-on module computing hardware 57 is connected to the respective relays 47 through the add-on module controlling wiring 58 and housed within an add-on module hardware case 59. The module interconnecting wires 56 lead to the master computing hardware 55, as shown in FIG. 8. As in the master module, the appropriate relay 47 will power the appropriate add-on module compartment locking device 10 through the electronic locking device wiring 12 and unlocks the locking device 10 from the key 11 when selection is made by the user.

As shown in FIG. 10, manual module assembly 80 may have larger module compartments, which can be useful for storing a large number of products in one compartment. Each compartment of the manual module assembly 80 can have physical padlocks 81, with the keys for those padlocks maintained by both onsite store personnel and vending personnel. A significant advantage of having the manual module assembly 80 is that the items held in the compartments can be accessed in the event of an electronic system failure or equipment failure of the master module assembly and the add-on module assemblies.

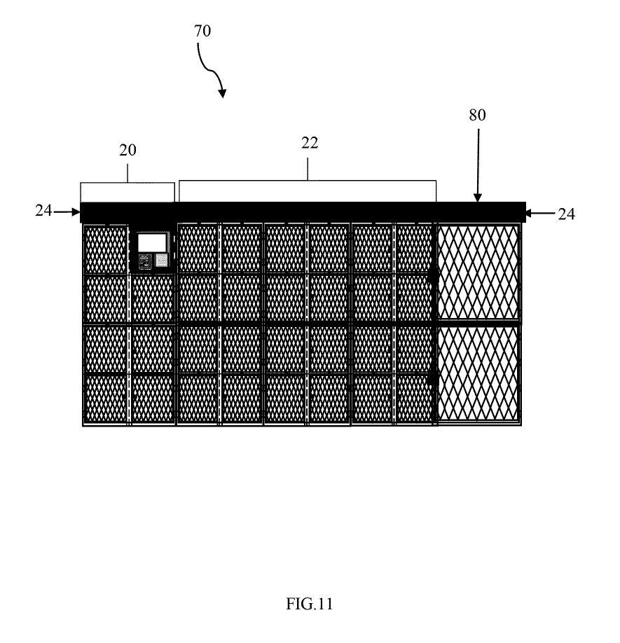

Referring to FIG. 11, a five-module setup of the modular vending system 70 of the present invention is shown. In this embodiment, the master module assembly 21 is connected to a series of add-on module assemblies 22 with the last add-on module assemblies 22 connected to a manual module assembly 80.

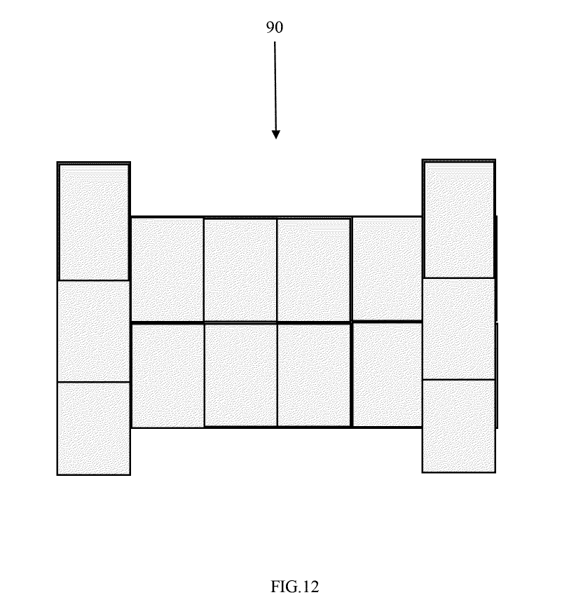

Referring to FIG. 12, modular vending system 70 is configured in a parking space setup 90. The parking space setup 90 can be in the parking lot of a store front, park, or campground.

Having thus described the various embodiments of the present invention, various methods of operating the modular vending system 70 will be described. In an embodiment, a user wishing to purchase a large item such as firewood approaches the modular vending system 70 and, facing the master module control compartment interface 30, can select an item. The user may optionally refer to the item/price list placard display 35 on the module compartment face 31. If the items in that module are sold out, the display will prompt the user to make another selection.

Once the item selection is made, the user presses the corresponding key on the product selection key pad 33. The product selection LCD display window 34 displays the price and item number and prompts the user to swipe their credit/debit card. The card reader interface 32 makes a wireless connection to the credit card verification company and determines the validity of the credit/debit card and whether the user has sufficient funds to purchase the item. Once the credit/debit card is confirmed, the product selection display window 34 will show that the sale has been authorized and also show from which compartment the item will be dispensed. Master computing hardware 55 can then determine if that item is in the master module assembly 20. If it is in the master module assembly 20, the master computing hardware will send a signal to the relay 47 controlling the first door containing the item. The relay 47 will in turn provide voltage to the appropriate electronic locking device 10 and door light 4 for a predetermined period of time. This unlocks the device 10 from the key 11 and the door will spring open. The door can still be reopened while voltage is applied in case the user accidently closes door prior to removal of the item. The door light 4 provides the necessary visibility in locating the correct item. The computing software is set in a manner that it only signals the relay 47 once and after the item is dispensed, the next selection of that item type will activate the next relay 47 until all items in that module are dispensed. Any further selections of that item type will may display a message, such as “sold out, make another selection”, on the card reader/interface 35 until the module is restocked and the master computing hardware 55 reset. Once the user removes the item from the compartment, the transaction is complete.

When an add-on module assembly 22 is connected to the master module assembly 20 or to another add-on module assembly 22 already in the system via add-on module interconnection wiring 56, the master computing hardware 55 will communicate with each add-on module computing hardware 57 and acquire the add-on module 22 via proprietary software and assimilate it into the system so that items can be dispensed from that particular add-on module 22. The number of add-on module assemblies 22 is generally unlimited with respect to the system requirements of modular vending system 70.

When the master computing hardware 55 determines the item is not in the master module assembly 20 it sends a signal to the appropriate add-on module computing hardware 57 containing the selected item. That add-on module computing hardware 57 will send a signal to the relay 47 controlling the first door in that module containing an item. The relay 47 will activate the door light 4 and the appropriate electronic locking device 10 in the same manner as described previously for the master module 20. Once the user removes the item from the add-on module assembly 22, the transaction is complete.

The master module computing hardware 55 and the related software can be used to set the price for the items in each module, determine when the module is empty and allows the user to select another item in another module, reset the modules when items are refilled, and run diagnostics to determine component failure. This is accomplished using the master control data entry keypad 51 and master control data and diagnostic display 52 to make inputs and view information.

In yet other embodiments of the modular vending system of the present invention, the modules can be made out of any metal or other sturdy material and the compartments can be of any size to accommodate intended items. The shapes of the compartments can also differ from those depicted in the figures to facilitate stocking and removal of items. Modules can also be arranged in multiple configurations that are not depicted in the common configuration drawings shown in the figures. In lieu of a cashless system, any sort of payment device may be substituted. The time that power is applied to the electronic locking devices can also vary. In this modular vending system of the present invention, two 12v DC batteries are provided that are continuously recharged by either AC power or solar power using a battery tender to maintain the batteries of the system although; however, one skilled in the art will recognize any power source may be used to power the vending system so that DC batteries are not required.

The various embodiments a modular vending system described herein should not be construed to limit the scope of the present invention. It is to be understood that the embodiments of the present invention as described herein do not limit any application or scope of the invention and that the invention can be carried out and practiced in various ways and implemented in embodiments other than the ones outlined in the description above. One skilled in the art will recognize that alternatives, modifications, and variations of the embodiments of the present invention may be construed as being within the spirit and scope of the present invention and the appended claims.

1-8. (canceled)

9. A modular vending system for vending items to a user, comprising:
a first module assembly comprising a plurality of first module compartments, each first module compartment having a locking mechanism and a compartment door providing access to an interior space of the first module compartment;
first module computing hardware for actuating each locking mechanism of the first module assembly;
a master module control operably connected to the first module computing hardware for selectively initiating actuation of each locking mechanism between a locked position and an unlocked position; and
a power management system supplying electrical power to the first module computing hardware, the master module control, and each locking mechanism.

10. The modular vending system of claim 9, wherein for each of the plurality of first module compartments, the compartment door is secured shut when the locking mechanism is in the locked position and the compartment door can be opened so that the user can remove an item from the interior space when the locking mechanism is in the unlocked position.

11. The modular vending system of claim 11, wherein the power management system further comprises:
a first battery; and
a battery tender adapted to charge the first battery with electrical power from an electrical source.

12. The modular vending system of claim 11, wherein the power management system further comprises a second battery, the battery tender being adapted to charge the second battery with electrical power from the electrical source.

13. The modular vending system of claim 12, further comprising:
a plurality of first module relays, each of the plurality of first module relay operably connecting one of the locking mechanisms of the plurality of first module compartments to the first module computing hardware; and
a transformer operably connected to the first and second batteries, the first module computing hardware, and the plurality of first module relays.

14. The modular vending system of claim 13, wherein the power management system further comprises:
an at least one solar panel; and
a charger controller adapted to charge the first and second batteries.

15. The modular vending system of claim 14, wherein the electrical power from the electrical source is DC power from the at least one solar panel or AC power from an external source.

16. The modular vending system of claim 15, wherein the first module computing hardware, the master module control, and the power management system are housed within one of the plurality of first module compartments of the first module assembly.

17. The modular vending system of claim 16, wherein:
the first and second batteries are 12-volt DC batteries connected in series; and
the transformer reduces voltage as required by the computing hardware and the first master module control.

18. The modular vending system of claim 11, wherein the first module computing hardware, the master module control, and the power management system are housed within one of the plurality of first module compartments of the first module assembly.

19. The modular vending system of claim 10, wherein the master module control further comprises:
a user-input interface adapted to receive a form of payment from the user; and
a display adapted to communicate data concerning the items within the plurality of first module compartments.

20. The modular vending system of claim 19, wherein:
the user-input interface is further adapted to receive an item selection from the user and transmit a signal indicative of the item selection to the first module computing hardware; and
the first module computing hardware is adapted to identify one of the plurality of first module compartments based on the item selection.

21. The modular vending system of claim 20, wherein the first module computing hardware is further adapted to actuate into the unlocked position the locking mechanism of one of the plurality of first module compartments containing at least one of the items based on the item selection.

22. The modular vending system of claim 21, wherein after the user removes the at least one of the items from the interior space, the locking mechanism of the one of the plurality of first module compartments automatically mechanically occupies the locked position when the compartment door of the one of the plurality of first module compartments is closed.

23. The modular vending system of claim 19, wherein the master module control and the power management system are housed within one of the plurality of first module compartments.

24. The modular vending system of claim 10, further comprising:
a second module assembly comprising a plurality of second module compartments, each second module compartment having a locking mechanism and a compartment door providing access to an interior space of the second module compartment; and
second module computing hardware for actuating each locking mechanism of the second module assembly;
wherein the master module control is operably connected to the second module computing hardware for selectively initiating actuation of each locking mechanism of the second module assembly between the locked position and the unlocked position.

25. The modular vending system of claim 24, wherein for each of the plurality of second module compartments, the compartment door is secured shut when the locking mechanism is in the locked position and the compartment door can be opened so that a user can remove an item from the interior space when the locking mechanism is in the unlocked position.

26. The modular vending system of claim 25, further comprising:
a plurality of first module relays, each of the plurality of first module relays operably connecting one of the locking mechanisms of the plurality of first module compartments to the first module computing hardware;
a plurality of second module relays, each of the plurality of second module relays operably connecting one of the locking mechanisms of the plurality of second module compartments to the second module computing hardware; and
a transformer operably connected to the first and second batteries, the first module first module computing hardware, and the plurality of first module relays;
wherein the first module relay is operably connected to the second module relay and the first module computing hardware is operably connected to the second module computing hardware.

27. The modular vending system of claim 26, wherein the power management system further comprises:
a first battery; and
a battery tender adapted to charge the first battery with electrical power from an electrical source.

28. The modular vending system of claim 27, wherein the power management system further comprises a second battery, the battery tender being adapted to charge the second battery with electrical power from the electrical source.

29. The modular vending system of claim 28, wherein the power management system further comprises:
an at least one solar panel; and
a charger controller adapted to charge the first and second batteries.

30. The modular vending system of claim 29, wherein the electrical power from the electrical source is DC power from the at least one solar panel or AC power from an external source.

31. The modular vending system of claim 30, wherein:
the first and second batteries are 12-volt DC batteries connected in series; and
the transformer reduces voltage as required by the computing hardware and the first master module control.

32. A method of vending an item to a user, comprising:
providing a modular vending system comprising:
a first module assembly comprising a plurality of first module compartments, each first module compartment having a locking mechanism and a compartment door; and
a master module control;
receiving a request from the user via the master module control to vend the item; and
unlocking the compartment door of one of the plurality of first module compartments, the item occupying the one of the plurality of first module compartments.

33. The method of claim 32, further comprising:
locking the compartment door of the one of the plurality of first module compartments after the user has removed the item.

34. The method of claim 33, wherein the item is one of a plurality of items, the method further comprising:
communicating the availability of each of the plurality of items to the user; and
communicating the price of at least the item to the user.

35. The method of claim 34, further comprising:
accepting payment for the item from the user.

36. The method of claim 35, wherein the step of unlocking the compartment door of one of the plurality of first module compartments includes the steps of:
sending an unlocking signal from the master module control to first module computing hardware; and
routing a corresponding unlocking signal from the first module computing hardware to a locking mechanism of the one of the plurality of first module compartments.

37. The method of claim 32, wherein the item is one of a plurality of items and the modular vending system further comprises a second module assembly comprising a plurality of second module compartments, each second module compartment having a locking mechanism and a compartment door, the method further comprising:
operably connecting the first module assembly to the second module assembly;
receiving a request from a second user via the master module control to vend a second item; and
unlocking the compartment door of one of the plurality of second module compartments, the second item occupying the one of the plurality of second module compartments

38. The method of claim 37, further comprising the step of:
locking the compartment door of the one of the plurality of second module compartments after the second user has removed the second item.

39. The method of claim 38, further comprising the steps of:
communicating the availability of each of the plurality of items to a user; and
communicating the price of at least the second item to the second user.

40. The method of claim 39, further comprising the steps of:
accepting payment for the second item from the second user.

41. The method of claim 40, wherein the step of unlocking the compartment door of one of the plurality of second module compartments includes the steps of:
sending an unlocking signal from the master module control to second module computing hardware via first module computing hardware; and
routing a corresponding unlocking signal from the second module computing hardware to a locking mechanism of the one of the plurality of second module compartments.

42. A method of assembling a modeling vending system, comprising:
providing a modular vending system comprising:
a first module assembly comprising a plurality of first module compartments, each first module compartment having a compartment door and a locking mechanism operably connected to the master module control via first module computing hardware;
a master module control; and
a power management system.
housing the master module control in one of the plurality of first module compartments; and
operably connecting the power management system to the master module control and the locking mechanism of each of the plurality of first modular compartments.

43. The method of claim 42, wherein the modular vending system further comprises a second module assembly comprising a plurality of second module compartments, each second module compartment having a compartment door and a locking mechanism, the method further comprising:
securing the second module assembly to the first module assembly; and
operably connecting to the second module computing hardware to the first module computing hardware.

44. The method of claim 43, wherein the step of operably connecting the second module computing hardware to the first module computing hardware includes the step of coupling a wiring harness of the first module computing hardware to the second module computing hardware.

45. The method of claim 44, further comprising the steps of:
charging an at least one battery; and
providing electrical power from the at least one battery to the master module control.

46. The method of claim 45, wherein the step of charging an at least one battery includes the step of using electrical power obtained from a solar power source or an external AC power source and the electrical power is DC power.

47. An add-on module for a modular vending system, comprising:
an add-on module assembly comprising a plurality of add-on module compartments, each add-on module compartment having a locking mechanism and a compartment door providing access to an interior space of the add-on module compartment; and
add-on module computing hardware for actuating each locking mechanism of the add-on module assembly;
wherein the modular vending system comprises:
a first module assembly comprising a plurality of first module compartments, each first module compartment having a locking mechanism and a compartment door providing access to an interior space of the first module compartment;
first module computing hardware for actuating each locking mechanism of the first module assembly;
a master module control operably connected to the first module computing hardware for selectively initiating actuation of each locking mechanism between a locked position and an unlocked position and to the add-on module computing hardware for selectively initiating actuation of each locking mechanism of the add-on module assembly between the locked position and the locked position; and
a power management system supplying electrical power to the first module computing hardware, the master module control, and each locking mechanism.

48. A modular vending system for vending items to a user, comprising:
a first module assembly comprising a plurality of first module compartments, each first module compartment having a locking mechanism and a compartment door providing access to an interior space of the first module compartment;
a second module assembly comprising a plurality of second module compartments, each second module compartment having a locking mechanism and a compartment door providing access to an interior space of the second module compartment; and
first module computing hardware for actuating each locking mechanism of the first module assembly;
second module computing hardware for actuating each locking mechanism of the second module assembly, the second module computing hardware operably connected to the first module computing hardware;
a master module control operably connected to the first module computing hardware and the second module computing hardware for selectively initiating actuation of each locking mechanism between a locked position and an locked position; and
a power management system supplying electrical power to the first module computing hardware, the second module computing hardware, the master module control, and the locking mechanisms;
wherein for each of the plurality of first and second module compartments, the compartment door is secured shut when the locking mechanism is in the locked position the compartment door can opened so that the user can remove an item from the interior space when the locking mechanism is in the unlocked position.

49. The modular vending system of claim 48, further comprising:
a plurality of first module relays, each of the plurality of first module relay operably connecting one of the locking mechanisms of the plurality of first module compartments to the first module computing hardware to; and
a plurality of second module relays, each of the plurality of second module relays operably connecting one of the locking mechanisms of the plurality of second module compartments to the second module computing hardware.

50. The modular vending system of claim 49, wherein the power management system further comprises:
a first battery;
a battery tender adapted to charge the first battery with electrical power from an electrical source;
an at least one solar panel;
a charger controller adapted to charge the first and second batteries; and
a transformer operably connected to the first and second batteries, the first module first module computing hardware, and the first module relay;
wherein the electrical power from the electrical source is DC power from the at least one solar panel or AC power from an external source.

51. The modular vending system of claim 50, wherein:
the power management system further comprises a second battery;
the first and second batteries are 12-volt DC batteries connected in series; and
the transformer reduces voltage as required by the computing hardware and the first master module control.
